(19) United States
(12) Patent Application Publication
(10) Pub. No.: US 2026/0042203 A1
(43) Pub. Date: Feb. 12, 2026

(54) Parallel robot with three limbs and five degrees of freedom

(71) Applicant: TIANJIN UNIVERSITY, Tianjin (CN)

(72) Inventors: Tao Sun, Tianjin (CN); Kaixuan Chen, Tianjin (CN); Panfeng Wang, Tianjin (CN); Yimin Song, Tianjin (CN); Binbin Lian, Tianjin (CN)

(21) Appl. No.: 18/873,550

(22) PCT Filed: Jun. 29, 2023
(86) PCT No.: PCT/CN2023/103883

§ 371 Date: Sep. 6, 2025

(30) Foreign Application Priority Data
Nov. 16, 2022 (CN) 202211432050.8
Nov. 16, 2022 (CN) 202211432084.7
Nov. 16, 2022 (CN) 202211436721.8

(51) Int. Cl. B25J 9/16; B25J 9/00; B25J 17/00

(52) U.S. Cl. CPC B25J 9/1623; B25J 9/0009; B25J 9/003; B25J 17/00

(57) ABSTRACT

A parallel robot with three limbs and five degrees of freedom includes: a static platform as a support base, and a movable platform as a position adjustment, wherein a machining output unit is provided on the movable platform for executing actions; an unconstrained limb group is provided between the static platform and the movable platform, and a constrained limb is also provided between the static platform and movable platform for constraining; the constrained limb moves between the unconstrained limb group, or between extension lines of the unconstrained limb group. The present invention comprises three limbs which are connected to the movable platform through movable joints. The three limbs are connected to the static platform through kinematic pairs. Positional and angular stiffness of the robot can be ensured by proportional constraints on a triangle surrounded by the movable joints as well as a triangle surrounded by connecters on the kinematic pairs. The present invention has the structural advantages of high stiffness and large workspace, which is capable of efficient machining of core components for large-scale high-end equipment.

### BACKGROUND OF THE PRESENT INVENTION

### FIELD OF INVENTION

The present invention relates to a technical field of industrial robots, and more particularly to a parallel robot with three limbs and five degrees of freedom.

### Description of Related Arts

Conventionally, industrial robots play an important role in the manufacturing industry, especially in the major advanced equipment, core components, high-performance materials and high-tech manufacturing processes, where parallel robots have a pivotal position. Accompanied by the development of national major projects, high-end equipment industry has raised higher efficiency and quality requirements on the core components. In order to satisfy high stiffness and large workspace machining of core components in the high-end equipment, it is effective to design a robot with five-axis linkage machining capability.

Some conventional five-degree-of-freedom industrial robots provide large stiffness but small workspace. For example, although the stiffness of the five-degree-of-freedom parallel industrial robot structure disclosed in Chinese Patent CN113319827A is outstanding, the mechanism arrangement of the structure restricts the swing range of its end actuator, which can hardly satisfy the efficient machining of large structural parts.

In order to improve the deficiencies of the above five-degree-of-freedom parallel industrial robots and to meet the machining needs of large and complex parts, there is an urgent need to propose a five-degree-of-freedom parallel industrial robot with both the high stiffness and the large workspace, as well as solutions for the efficient and high-quality machining of major high-end equipment.

### SUMMARY OF THE PRESENT INVENTION

To solve the problems in the prior art, an object of the present invention is to provide a parallel robot with three limbs and five degrees of freedom.

Accordingly, the present invention provides: a parallel robot with three limbs and five degrees of freedom, comprising: a static platform as a support base, and a movable platform as a position adjustment, wherein a machining output unit is provided on the movable platform for executing actions; an unconstrained limb group is provided between the static platform and the movable platform, and a constrained limb is also provided between the static platform and movable platform for constraining; the constrained limb moves between the unconstrained limb group, or between extension lines of the unconstrained limb group.

Preferably, unconstrained limbs in the unconstrained limb group are connected to the static platform through first kinematic pairs, and the other ends of the unconstrained limbs are connected to the movable platform through movable joints.

Preferably, the unconstrained limb group comprises a first limb and a second limb, which are symmetrically disposed on the static platform.

Preferably, a mobile base of the first kinematic pairs is set on the static platform, along which mobile units of the first kinematic pairs move linearly; and first rotating pairs are provided on the mobile units of the first kinematic pairs.

Preferably, one ends of the first rotating pairs are connected to second kinematic pairs, and the second kinematic pairs move telescopically.

Preferably, one ends of the second kinematic pairs are connected to the movable platform through the movable joints.

Preferably, the constrained limb is a third limb, which comprises a first Hooke joint connected to a back portion of the movable platform.

Preferably, the third limb comprises a third kinematic pair, a fourth kinematic pair, the first Hooke joint and a second rotating pair; wherein the third kinematic pair is arranged between the first Hooke joint and the second rotating pair, and the fourth kinematic pair is arranged at ends of the third kinematic pair and the second rotating pair;

wherein the third kinematic pair of the third limb is independently driven by a motor to move telescopically, the first Hooke joint and the second rotating pair on different ends of the third kinematic pair cooperate with the fourth kinematic pair to move, thereby moving the movable platform to a predetermined position, and providing the five degrees of freedom to the movable platform.

Preferably, the third limb comprises a third kinematic pair, the first Hooke joint and a second Hooke joint; wherein the second Hooke joint is arranged between the first Hooke joint and the third kinematic pair;

wherein the third kinematic pair of the third limb is independently driven by a motor to slide, which cooperates with the first Hooke joint and the second Hooke joint of the third limb to execute a corresponding motion under a predetermined position, and to provide the five degrees of freedom to the movable platform.

Preferably, the third limb comprises a third kinematic pair, the first Hooke joint and a third Hooke joint; wherein the third kinematic pair is arranged between the first Hooke joint and the third Hooke joint;

wherein the third kinematic pair of the third limb is independently driven by a motor or a hydraulic device to move telescopically; the third kinematic pair cooperates with the first Hooke joint and the third Hooke joint on different ends to move the movable platform (2) to a predetermined position, and to provide the five degrees of freedom to the movable platform (2).

Beneficial effects of the present invention are as follows.

The present invention comprises three limbs which are connected to the movable platform through movable joints. The three limbs are connected to the static platform through kinematic pairs. Positional and angular stiffness of the robot can be ensured by proportional constraints on a triangle surrounded by the movable joints as well as a triangle surrounded by connecters on the kinematic pairs.

The present invention has the structural advantages of high stiffness and large workspace, which is capable of efficient machining of core components for large-scale high-end equipment.

### BRIEF DESCRIPTION OF THE DRAWINGS

FIG. 1 is a perspective view of a first structure according to an embodiment 1 of the present invention;

FIG. 2 is a perspective view of a first limb according to the first structure of the present invention;

FIG. 3 is a perspective view of a third limb according to the first structure of the present invention;

FIG. 4 is a perspective view of the first structure according to an embodiment 2 of the present invention;

FIG. 5 is a perspective view of the first structure according to an embodiment 3 of the present invention;

FIG. 6 is a perspective view of a second structure according to the embodiment 1 of the present invention;

FIG. 7 is a perspective view of a first limb according to the second structure of the present invention;

FIG. 8 is a perspective view of a third limb according to the second structure of the present invention;

FIG. 9 is a perspective view of the second structure according to the embodiment 2 of the present invention;

FIG. 10 is a perspective view of the second structure according to the embodiment 3 of the present invention;

FIG. 11 is a perspective view of the second structure according to an embodiment 4 of the present invention;

FIG. 12 is a perspective view of a third structure according to the embodiment 1 of the present invention;

FIG. 13 is a perspective view of a first limb according to the third structure of the present invention;

FIG. 14 is a perspective view of a third limb according to the third structure of the present invention;

FIG. 15 illustrates an alternative structure of the first limb according to the third structure of the present invention; and FIG. 16 is a perspective view of the third structure according to the embodiment 2 of the present invention.

### ELEMENT REFERENCES

1: static platform; 2: movable platform;
3: electric spindle; 4: ball hinge;
L1: first limb; L2: second limb;
L3: third limb;
P1: first kinematic pair; P2: second kinematic pair;
P3: third kinematic pair; P4: fourth kinematic pair;
R1: first rotating pair; R2: second rotating pair;
U1: first Hooke joint; U2: second Hooke joint;
U3: third Hooke joint.

### DETAILED DESCRIPTION OF THE PREFERRED EMBODIMENT

The present invention will be further described with reference to the accompanying drawings and embodiments.

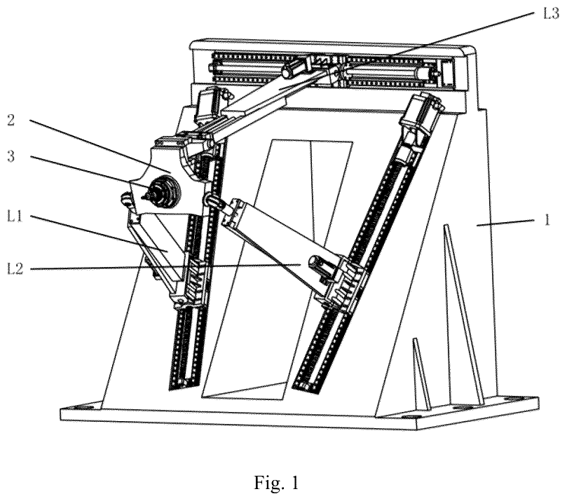

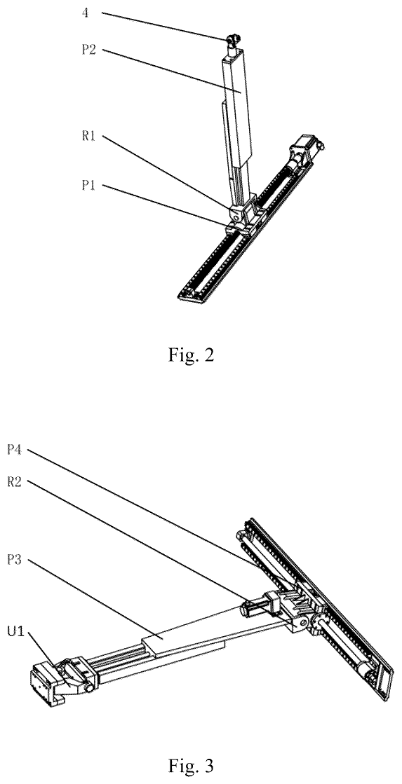

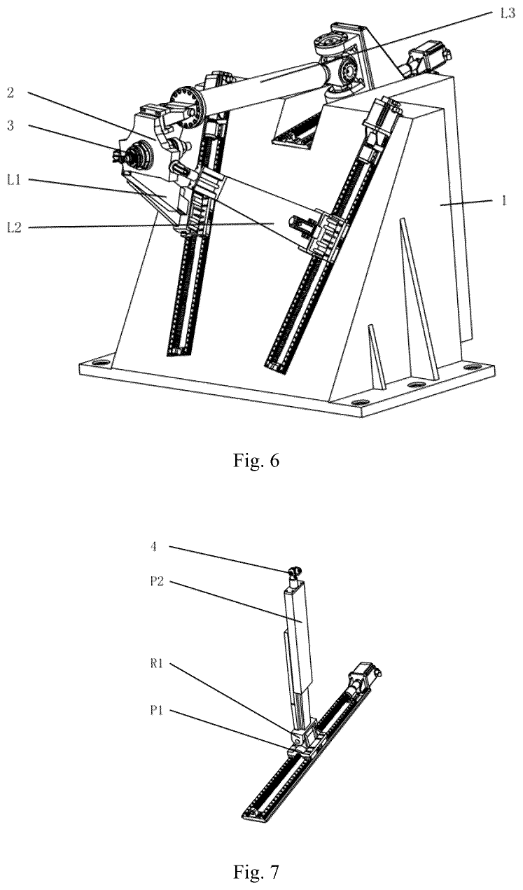

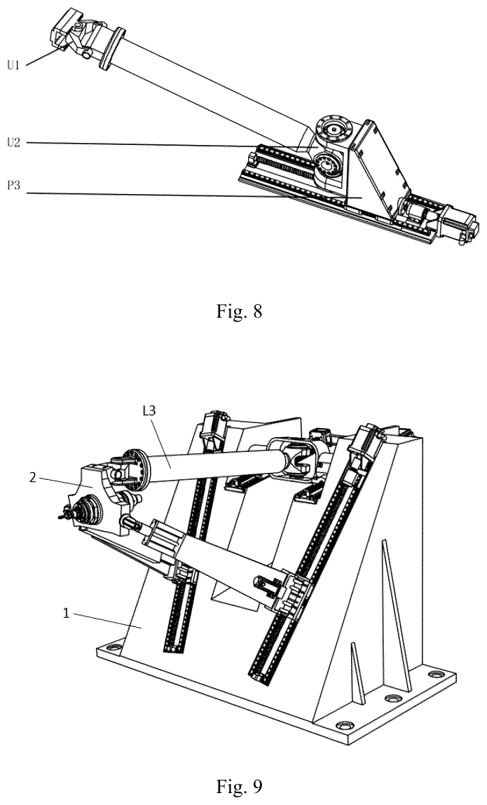

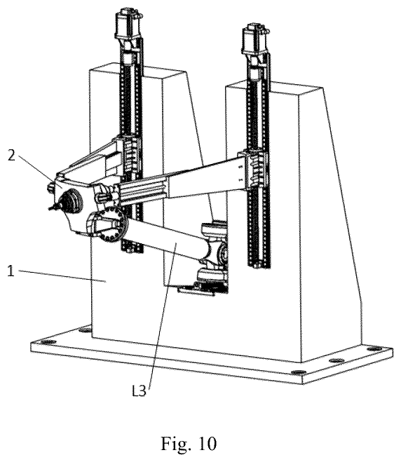

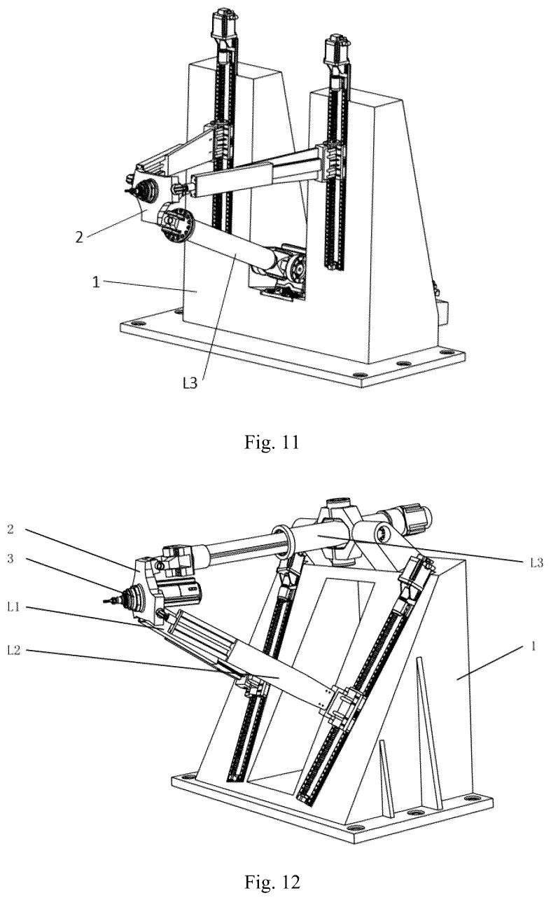

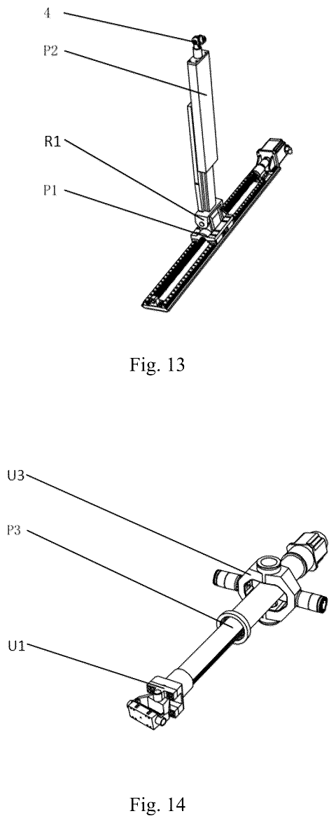

Referring to FIGS. 1-16, a parallel robot with three limbs and five degrees of freedom is illustrated, comprising: a static platform 1 as a support base, and a movable platform 2 as a position adjustment, wherein a machining output unit is provided on the movable platform 2 for executing actions; an unconstrained limb group is provided between the static platform 1 and the movable platform 2, and a constrained limb is also provided between the static platform 1 and movable platform 2 for constraining; the constrained limb moves between the unconstrained limb group, or between extension lines of the unconstrained limb group.

Preferably, unconstrained limbs in the unconstrained limb group are connected to the static platform 1 through first kinematic pairs, and the other ends of the unconstrained limbs are connected to the movable platform 2 through movable joints.

Preferably, the unconstrained limb group comprises a first limb L1 and a second limb L2, which are symmetrically disposed on the static platform 1.

Preferably, a mobile base of the first kinematic pairs P1 is set on the static platform 1, along which mobile units of the first kinematic pairs P1 move linearly; and first rotating pairs R1 are provided on the mobile units of the first kinematic pairs P1.

Preferably, one ends of the first rotating pairs R1 are connected to second kinematic pairs P2, and the second kinematic pairs P2 move telescopically.

Preferably, one ends of the second kinematic pairs P2 are connected to the movable platform 2 through the movable joints.

Preferably, the constrained limb is a third limb L3, which comprises a first Hooke joint U1 connected to a back portion of the movable platform 2.

Preferably, the third limb L3 comprises a third kinematic pair P3, a fourth kinematic pair P4, the first Hooke joint U1 and a second rotating pair R2; wherein the third kinematic pair P3 is arranged between the first Hooke joint U1 and the second rotating pair R2, and the fourth kinematic pair P4 is arranged at ends of the third kinematic pair P3 and the second rotating pair R2;

wherein the third kinematic pair P3 of the third limb L3 is independently driven by a motor to move telescopically, the first Hooke joint U1 and the second rotating pair R2 on different ends of the third kinematic pair P3 cooperate with the fourth kinematic pair P4 to move, thereby moving the movable platform 2 to a predetermined position, and providing the five degrees of freedom to the movable platform 2.

Preferably, the third limb L3 comprises a third kinematic pair P3, the first Hooke joint U1 and a second Hooke joint U2; wherein the second Hooke joint U2 is arranged between the first Hooke joint U1 and the third kinematic pair P3;

wherein the third kinematic pair P3 of the third limb L3 is independently driven by a motor to slide, which cooperates with the first Hooke joint U1 and the second Hooke joint U2 of the third limb L3 to execute a corresponding motion under a predetermined position, and to provide the five degrees of freedom to the movable platform 2.

Preferably, the third limb L3 comprises a third kinematic pair P3, the first Hooke joint U1 and a third Hooke joint U3; wherein the third kinematic pair P3 is arranged between the first Hooke joint U1 and the third Hooke joint U3;

wherein the third kinematic pair P3 of the third limb L3 is independently driven by a motor or a hydraulic device to move telescopically; the third kinematic pair P3 cooperates with the first Hooke joint U1 and the third Hooke joint U3 on different ends to move the movable platform 2 to a predetermined position, and to provide the five degrees of freedom to the movable platform 2.

A first structure of the parallel robot is shown in FIGS. 1-5.

The parallel robot comprises: a static platform 1 as a support base, and a movable platform 2 as a position adjustment, wherein a machining output unit is provided on the movable platform 2 for executing actions; an unconstrained limb group is provided between the static platform 1 and the movable platform 2, and a constrained limb is also provided between the static platform 1 and movable platform 2 for constraining; one end of the constrained limb is connected to the static platform 1 through a fourth kinematic pair P4, and the fourth kinematic pair P4 moves between the unconstrained limb group, or between extension lines of the unconstrained limb group.

Unconstrained limbs in the unconstrained limb group are connected to the static platform 1 through first kinematic pairs P1, and the other ends of the unconstrained limbs are connected to the movable platform 2 through movable joints.

The unconstrained limb group comprises a first limb L1 and a second limb L2, which are symmetrically disposed on the static platform 1.

A mounting ramp is formed on the static platform 1, and the first limb L1 and the second limb L2 are provided on the mounting ramp, wherein extension lines of the two first kinematic pairs P1 of the first limb L1 and second limb L2 are parallel or intersect.

A mobile base of the constrained limb is set on the static platform 1, along which a mobile unit of the constrained limb moves linearly; and a second rotating pair R2 is provided on the mobile unit of the constrained limb.

One end of the second rotating pair R2 is connected to a third kinematic pair P3, and the third kinematic pair P3 moves telescopically.

One end of the third kinematic pair P3 is connected to the movable platform 2 through the movable joint.

A mobile base of the first kinematic pairs P1 is set on the mount ramp of the static platform 1, along which mobile units of the first kinematic pairs P1 move linearly; and first rotating pairs R1 are provided on the mobile units of the first kinematic pairs P1.

One ends of the first rotating pairs R1 are connected to second kinematic pairs P2, and the second kinematic pairs P2 move telescopically.

One ends of the second kinematic pairs P2 are connected to the movable platform 2 through the movable joints.

Specifically, the unconstrained limb group cooperates with the constrained limb to adjust the position of the movable platform 2. The movable platform 2 provides a mounting support for the machining output unit. At the same time, the machining output unit is adjusted along with the movable platform 2 to perform a five-degree-of-freedom motion.

Specifically, the machining output unit may adopt, but is not limited to, an electric spindle 3, which provides power for machining.

Specifically, the constrained limb is a third limb L3. The first limb L1, the second limb L2 and the third limb L3 are all driven limbs, which means the first kinematic pairs P1 and the second kinematic pairs P2 in the first limb L1 and the second limb L2 are both driven by a driving member.

At least one of the third kinematic pair P3 and the fourth kinematic pair P4 in the third limb L3 is driven by the driving member.

Specifically, the unconstrained limb group comprises two unconstrained limbs, namely, the first limb L1 and the second limb L2. One ends of the first limb L1 and the second limb L2 are connected to the static platform 1 by the first kinematic pairs P1, and the other ends of the first limb L1 and the second limb L2 are connected to the movable platform by ball hinges 4. The first rotating pairs R1 are arranged between the first kinematic pairs P1 and the second kinematic pairs P2.

Specifically, the constrained limb is the third limb L3, wherein one end of the third limb L3 is connected to the movable platform 2 via the first Hooke joint U1, and the other end of the third limb L3 is connected to the static platform 1 via the fourth kinematic pair P4. The third kinematic pair P3 is provided between the first Hooke joint U1 and the second rotating pair R2.

Specifically, the movable joints of the first limb L1 and the second limb L2 are arranged on both sides of the movable platform 2. The first kinematic pairs P1 in both the first limb L1 and the second limb L2 are arranged symmetrically about a symmetry plane of the static platform. At the same time, the two first kinematic pairs P1 are parallel to each other or form a certain angle. The first limb L1 and the second limb L2 together are triangular.

Specifically, the movable joint of the third limb L3 and the movable joints of the first limb L1 and the second limb L2 together form apexes of a triangle. A connecting point of the second rotating pair R2 and connecting points of the two first rotating pairs together form apexes of another triangle.

More specifically, an area ratio of the two triangles is within a certain range.

Embodiment 1 of the first structure:

As shown in FIGS. 1-3, the parallel industrial robot comprises a static platform 1, a movable platform 2, an electric spindle 3, a first limb L1, a second limb L2, and a third limb L3.

Specifically, two ends of the first limb L1, the second limb L2 and the third limb L3 are connected to the static platform 1 and the movable platform 2, respectively; and the electric spindle 3 is fixed in the center of the movable platform 2, which collectively constitute a five-degree-of-freedom parallel industrial robot.

Specifically, each of the first limb L1 and the second limb L2 comprises the first kinematic pair P1, the second kinematic pair P2, the ball hinge 4, and the first rotating pair R1. The first rotating pair R1 is arranged between the first kinematic pair P1 and the second kinematic pair P2, and the second kinematic pair P2 is arranged between the ball hinge 4 and the first rotating pair R1.

Specifically, the third limb L3 comprises the third kinematic pair P3, the fourth kinematic pair P4, the first Hooke joint U1 and the second rotating pair R2. The third kinematic pair P3 is arranged between the first Hooke joint U1 and the second rotating pair R2, and the fourth kinematic pair P4 is arranged at the other ends of the third kinematic pair P3 and the second rotating pair R2.

Specifically, one ends of the two unconstrained limbs of identical structure among the three limbs, namely the first limb L1 and the second limb L2, are connected to the static platform 1 via the first kinematic pairs P1, and the other ends are connected to the movable platform 2 via the ball hinges 4. The first rotating pairs R1 are provided between the first kinematic pairs P1 and the second kinematic pairs P2, and the ball hinges 4 are provided at the other ends of the first rotating pairs R1 and the second kinematic pair P2. One end of the third limb L3 is connected to the movable platform 2 via the first Hooke joint U1, and the other end is connected to the static platform 1 via the fourth kinematic pair P4.

Specifically, the ball hinges 4 in the first limb L1 and the second limb L2 are arranged on two sides of the movable platform 2. The first limb L1 and the second limb L2 are connected to the static platform 1 with the first kinematic pair P1 arranged symmetrically about the static platform 1. The two first kinematic pairs P1 form a certain angle, and are inclined and arranged on the static platform 1. The two limbs arranged in accordance with the above requirements are triangular. The first Hooke joint U1 of the third limb L3 and the two ball hinges 4 form the apexes of a triangle. The connecting point of the second rotating pair R2 and the connecting points of the two first rotating pairs R1 form the apexes of another triangle. The area ratio of the two triangles ranges from 1:2 to 1:9.

Specifically, the first limb L1, the second limb L2 and the third limb L3 may be independently driven by a motor or a hydraulic device, which will not be further illustrated here.

The first kinematic pairs P1 of the first limb L1 and the second limb L2 are independently driven by the motor to realize translation movements of the connecting points of the first rotating pairs R1 and the first kinematic pairs P1. The second kinematic pairs P2 are independently driven by the motor or the hydraulic device to move telescopically. The second kinematic pairs P2 cooperate with the ball hinges 4 and the first rotating pairs R1 on the two ends to complete associated movement of a predetermined position of the movable platform 2.

Generally, the third kinematic pair P3 of the third limb L3 is independently driven by a motor to move telescopically, the first Hooke joint U1 and the second rotating pair R2 on different ends of the third kinematic pair P3 cooperate with the fourth kinematic pair P4 to move, thereby moving the movable platform 2 to a predetermined position, and providing the five degrees of freedom to the movable platform 2.

Embodiment 2 of the first structure:

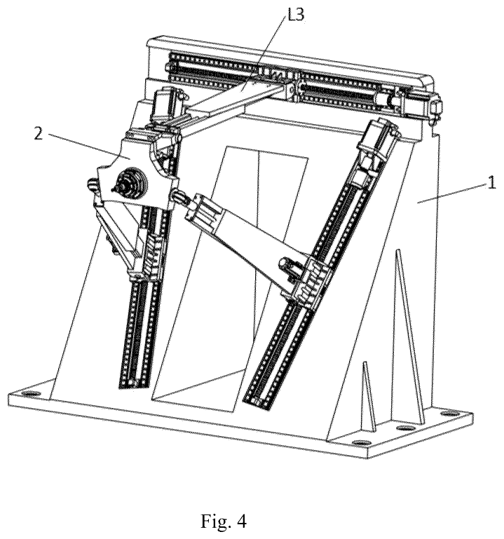

As shown in FIG. 4, a motion form of the parallel industrial robot in the embodiment 2 is the same as that in the embodiment 1, and composition forms of each kinematic pair, limb, and the like are identical.

According to the embodiment 2, the difference is that the fourth kinematic pair P4 in the third limb L3 is independently driven by a motor to realize translation movements of the connecting point of the second rotating pair R2.

The first Hooke joint U1, the second rotating pair R2, and the third kinematic pair P3 in the third limb L3 cooperate with each other to move, so as to bring the movable platform 2 to the predetermined position. The movement of the first limb L1 and the second limb L2 are combined, thereby providing the five degrees of freedom to the movable platform 2.

Embodiment 3 of the first structure:

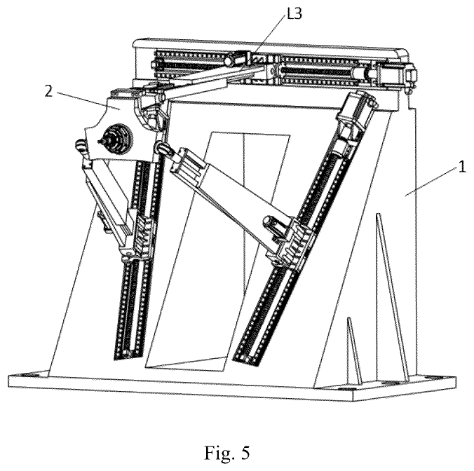

As shown in FIG. 5, a motion form of the parallel industrial robot in the embodiment 3 is the same as that in the embodiment 1, and composition forms of each kinematic pair, limb, and the like are identical.

According to the embodiment 3, the difference is that the third kinematic pair P3 and the fourth kinematic pair P4 of the third limb L3 are independently driven by the motor or the hydraulic device to realize translation movements of the connecting point of the second rotating pair R2 and telescopic movement of the third kinematic pair P3.

Driven by the above redundancy, the first Hooke joint U1 and the second rotating pair R2 in the third limb L3 cooperate with each other to move, so as to bring the movable platform 2 to the predetermined position. The movement of the first limb L1 and the second limb L2 are combined, thereby providing the five degrees of freedom to the movable platform 2.

A second structure of the parallel robot is shown in FIGS. 6-11.

The parallel robot comprises: a static platform 1 as a support base, and a movable platform 2 as a position adjustment, wherein a machining output unit is provided on the movable platform 2 for executing actions; an unconstrained limb group is provided between the static platform 1 and the movable platform 2, and a constrained limb is also provided between the static platform 1 and movable platform 2 for constraining; one end of the constrained limb is connected to the static platform 1 through a third kinematic pair P3, and a moving direction of the third kinematic pair P3 intersects with a plane in which the unconstrained limb group is located.

The third kinematic pair P3 is placed on the static platform 1, wherein the static platform 1 has a mounting place for installing the third kinematic pair P3.

The mobile base of the third kinematic pair P3 is connected to the static platform 1, along which a mobile unit of the third kinematic pair P3 moves linearly. The mobile unit is connected to a second Hooke joint U2.

One end of the second Hooke joint U2 is connected to a limb rod, and the other end of the limb rod is connected to the movable platform 2 through a movable joint.

The unconstrained limb group comprises a first limb L1 and a second limb L2, which are symmetrically disposed about a symmetry plane on the static platform 1.

The constrained limb is provided between the first limb L1 and the second limb L2.

A mounting ramp is formed on the static platform 1, and the first limb L1 and the second limb L2 are provided on the mounting ramp, wherein extension lines of the two first kinematic pairs P1 of the first limb L1 and second limb L2 are parallel or intersect.

The first limb L1, the second limb L2 and the constrained limb are connected to the movable platform 2 through movable joints.

The movable joints are provided at a back potion or side walls of the movable platform 2.

The movable joints are arranged in a triangular shape.

Specifically, the unconstrained limb group cooperates with the constrained limb to adjust the position of the movable platform 2. The movable platform 2 provides a mounting support for the machining output unit. At the same time, the machining output unit is adjusted along with the movable platform 2 to perform a five-degree-of-freedom motion.

Specifically, the machining output unit may adopt, but is not limited to, an electric spindle 3, which provides power for machining.

The mobile base of the first kinematic pairs P1 is provided on the mounting ramp of the static platform 1, along which the mobile units of the first kinematic pairs P1 move linearly; and first rotating pairs R1 are provided on the mobile unit of the first kinematic pairs P1.

One ends of the first rotating pairs R1 are connected to second kinematic pairs P2 which move telescopically.

One ends of the second kinematic pairs P2 are connected to the movable platform 2 through the movable joints.

Specifically, the constrained limb is a third limb L3. The first limb L1, the second limb L2 and the third limb L3 are all driven limbs, which means the first kinematic pairs P1 and the second kinematic pairs P2 in the first limb L1 and the second limb L2 are both driven by a driving member.

Specifically, the unconstrained limb group comprises two unconstrained limbs, namely, the first limb L1 and the second limb L2. One ends of the first limb L1 and the second limb L2 are connected to the static platform 1 by the first kinematic pairs P1, and the other ends of the first limb L1 and the second limb L2 are connected to the movable platform by ball hinges 4. The first rotating pairs R1 are arranged between the first kinematic pairs P1 and the second kinematic pairs P2.

Specifically, one end of the third limb L3 is connected to the static platform via the third kinematic pair P3, and the other end of the third limb L3 is connected to the movable platform 2 via the first Hooke joint U1.

More specifically, the mobile unit of the third kinematic pair P3 is triangular, and one end of the second Hooke joint U2 is fixed to the mobile unit.

Specifically, the movable joints of the first limb L1, the second limb L2 and the third limb L3 are triangularly arranged on an external wall of the movable platform 2, wherein the movable joints of the first limb L1 and the second limb L2 are the ball hinges 4, and the movable joint of the third limb L3 is the first Hooke joint U1.

Specifically, the connecting point of the second Hooke joint U2 are triangularly arranged with the connecting points of the first rotating pairs R1.

Specifically, the first kinematic pairs P1, the second kinematic pairs P2 and the third kinematic pair P3 in the first limb L1, the second limb L2 and the third limb L3 are independently driven by a screw or a hydraulic device, respectively, so as to realize a five-degree-of-freedom movement of the movable platform 2 by controlling positions of the three limbs with respect to the static platform and lengths of the three limbs.

Embodiment 1 of the second structure:

As shown in FIGS. 6-8, the parallel industrial robot comprises a static platform 1, a movable platform 2, an electric spindle 3, a first limb L1, a second limb L2, and a third limb L3.

Specifically, two ends of the first limb L1, the second limb L2 and the third limb L3 are connected to the static platform 1 and the movable platform 2, respectively; and the electric spindle 3 is fixed in the center of the movable platform 2, which collectively constitute a five-degree-of-freedom parallel industrial robot.

Specifically, each of the first limb L1 and the second limb L2 comprises the first kinematic pair P1, the second kinematic pair P2, the ball hinge 4, and the first rotating pair R1. The first rotating pair R1 is arranged between the first kinematic pair P1 and the second kinematic pair P2, and the ball hinge 4 is provided on one end of the second kinematic pair P2.

Specifically, the third limb L3 comprises the third kinematic pair P3, the first Hooke joint U1 and the second Hooke joint U2; wherein the second Hooke joint U2 is arranged between the first Hooke joint U1 and the third kinematic pair P3.

Specifically, structures of the first limb L1 and the second limb L2 are identical. One ends of the first limb L1 and the second limb L2 are connected to the static platform 1 via the first kinematic pairs P1, and the other ends are connected to the movable platform 2 via the ball hinges 4. The first rotating pairs R1 are provided between the first kinematic pairs P1 and the second kinematic pairs P2, and the ball hinges 4 are provided at the other ends of the second kinematic pairs P2.

One end of the third limb L3 is connected to the static platform 1 via the third kinematic pair P3, and the other end is connected to the movable platform 2 via the first Hooke joint U1.

Specifically, the ball hinges 4 in the first limb L1 and the second limb L2 are arranged on two sides of the movable platform 2. The first kinematic pairs P1 of the first limb L1 and the second limb L2 are arranged symmetrically about a symmetry plane of the static platform 1. The two first kinematic pairs P1 form a certain angle, and are inclined and arranged on the static platform 1. The first limb L1 and the second limb L2 together are triangular.

The connecting point of the first Hooke joint U1 and the two ball hinges 4 form the apexes of a triangle. The connecting point of the second Hooke joint U2 and the connecting points of the two first rotating pairs R1 form the apexes of another triangle. The area ratio of the two triangles ranges from 1:2 to 1:9.

According to the embodiment 1, the second Hooke joint U2 is hinged to the third kinematic pair P3 in an axis co-planar with the symmetry plane.

Specifically, the first limb L1, the second limb L2 and the third limb L3 may be independently driven by a motor or a hydraulic device. The first kinematic pairs P1 of the first limb L1 and the second limb L2 are independently driven by the motor to realize translation movements of the connecting points of the first rotating pairs R1 and the first kinematic pairs P1. The second kinematic pairs P2 are independently driven by the motor or the hydraulic device to move telescopically. The second kinematic pairs P2 cooperate with the ball hinges 4 and the first rotating pairs R1 on the two ends to complete associated movement of a predetermined position of the movable platform 2. Generally, the third kinematic pair P3 of the third limb L3 is independently driven by a motor to slide, and the first Hooke joint U1 and the second Hooke joint U2 of the third limb 3 also cooperate with the third kinematic pair P3 to perform corresponding movement of the predetermined position, and provide the five degrees of freedom to the movable platform 2.

Specifically, the mounting place on the static platform 1 is a mounting slot, which fulfills the mounting of the mobile base of the third kinematic pair P3. The second Hooke joint U2 probes out of the mounting slot, thereby avoiding motion interference with the mounting slot when the second Hooke joint U2 is in action.

Specifically, the mounting slot is located on a top portion of the static platform 1.

Embodiment 2 of the second structure:

As shown in FIG. 9, a motion form of the parallel industrial robot in the embodiment 2 is the same as that in the embodiment 1, and composition forms of each kinematic pair, limb, and the like are identical.

According to the embodiment 2, the difference is that the hinge axes of the second Hooke joint U2 and the first kinematic pairs P1 are orthogonal to the symmetry plane, and the hinge axes of the first Hooke joint U1 and the second Hooke joint U2 are parallel.

The mounting place on the static platform 1 is a mounting slot, wherein a guide groove is from on a bottom of the mounting slot. The guide groove facilitates the movement of the third limb L3 and avoids movement interference with the static platform 1.

Embodiment 3 of the second structure:

A motion form of the parallel industrial robot in the embodiment 3 is the same as that in the embodiment 1, and composition forms of each kinematic pair, limb, and the like are identical.

According to the embodiment 3, the difference is that the mounting slot is arranged at a bottom end of the static platform 1, so that the third kinematic pair P3 is always below the first kinematic pairs P1. With the foregoing structure, the movable platform 2 in the embodiment 3 is mounted upside-down compared with that in the embodiment 1, which means the first limb L1, the second limb L2, and the third limb L3 and the movable platform 2 are flipped as a whole.

The ball hinges 4 in the first limb L1 and the second limb L2 are arranged on two sides of the movable platform 2. The first kinematic pairs P1 are arranged symmetrically about a symmetry plane of the static platform 1. The two first kinematic pairs P1 are parallel to each other, and are vertically arranged on the mounting plane of the static platform 1. The movable joint of the first Hooke joint U1 and the two ball hinges 4 form the apexes of a triangle. The connecting point of the second Hooke joint U2 and the connecting points of the two first rotating pairs R1 form the apexes of another triangle. The area ratio of the two triangles ranges from 1:2 to 1:9.

Specifically, the connecting point of the second Hooke joint U2 is coplanar with the symmetry plane.

The first kinematic pairs P1 and the second kinematic pairs P2 are independently driven by the screw or the hydraulic cylinder to move telescopically. The ball hinges 4 and the first rotating pairs R1 cooperate to move, so as to reach the predetermined position of the movable platform 2. The third kinematic pair P3 is independently driven by the motor to slide, wherein the first Hooke joint U1 and the second Hooke joint U2 also cooperate with the third kinematic pair P3 to reach the predetermined position of the movable platform 2. Thus, the movable platform 2 is capable of five degrees of freedom.

Embodiment 4 of the second structure:

A motion form of the parallel industrial robot in the embodiment 2 is the same as that in the embodiment 3, and composition forms of each kinematic pair, limb, and the like are identical.

According to the embodiment 4, the difference is that the hinge axes of the second Hooke joint U2 and the static platform 1 are orthogonal to the symmetry plane, and the hinge axes of the first Hooke joint U1 and the second Hooke joint U2 are parallel. The axis of the second Hooke joint U2 is parallel to the connecting points between the first limb L1, the second limb L2 and the movable platform 2.

A third structure of the parallel robot is shown in FIGS. 12-16.

The parallel robot comprises: a static platform 1 as a support base, and a movable platform 2 as a position adjustment, wherein a machining output unit is provided on the movable platform 2 for executing actions; an unconstrained limb group is provided between the static platform 1 and the movable platform 2, and a constrained limb is also provided between the static platform 1 and movable platform 2 for constraining; the constrained limb comprises a third Hooke hinge U3 movably connected to the static platform 1, and the constrained limb rotates around a hinge axis of the third Hooke joint U3.

The third Hooke joint U3 is connected to a third kinematic pair P3, the third kinematic pair P3 is a telescopic kinematic pair.

A movable end of the third kinematic pair P3 is connected to the first Hooke joint U1.

One end of the first Hooke joint U1 is connected to the movable platform 2.

The static platform 1 has a mounting place for installing the third Hooke joint U3.

The unconstrained limb group comprises a first limb L1 and a second limb L2, which are symmetrically disposed about a symmetry plane on the static platform 1.

One ends of the first limb L1 and the second limb L2 are connected to the movable platform 2 through movable joints.

Each of the first limb L1 and the second limb L2 comprises a ball hinge 4, a second kinematic pair P2, a first rotating pair R1, and a first kinematic pair P1.

Hinge places are set on mobile units of the first kinematic pairs P1 of the first limb L1 and the second limb L2, wherein the above two hinge places are arranged triangularly together with a hinge place of the third Hooke joint U3.

The static platform 1 has a mounting place for mounting the static platform 1.

Specifically, the unconstrained limb group cooperates with the constrained limb to adjust the position of the movable platform 2. The movable platform 2 provides a mounting support for the machining output unit. At the same time, the machining output unit is adjusted along with the movable platform 2 to perform a five-degree-of-freedom motion.

Specifically, the machining output unit may adopt, but is not limited to, an electric spindle 3, which provides power for machining.

Specifically, the mounting place of the static platform 1 is formed by two parallel support arms provided on the static platform 1, wherein the third Hooke joint U3 is provided between the two support arms.

Specifically, the mounting place of the static platform 1 is a mounting flange provided on the bottom or the back, through which the static platform 1 can be fixed for installation.

Specifically, the first limb L1, the second limb L2 and the third limb L3 are all driven limbs. Structures of the first limb L1 and the second limb L2 are identical. One ends of the first limb L1 and the second limb L2 are connected to the static platform through the first kinematic pairs P1.

Specifically, the mobile units on the first kinematic pairs P1 are connected to the first rotating pairs R1, and the first rotating pairs R1 are connected to the second kinematic pairs P2. The other ends of the second kinematic pairs P2 are connected to the ball hinges 4, and the ball hinges 4 are connected to an external wall of the movable platform 2.

Alternatively, the mobile units on the first kinematic pairs P1 are connected to the ball hinges 4, and the other ends of the ball hinges 4 are connected to the second kinematic pairs P2. The other ends of the second kinematic pairs P2 are connected to the first rotating pairs R1, and the first rotating pairs R1 are connected to the external wall of the movable platform 2.

Specifically, the constrained limb is the third limb L3, which is provided on a top of the static platform 1, and will not collide with the static platform 1 during action.

Specifically, the first limb L1 and second limb L2 are triangular. The movable joints of the first limb L1 and the second limb L2 at the external wall of the movable platform 2 and the connecting point of the first Hooke joint U1 form apexes of a triangle. The connecting point of the third Hooke joint U3 and the connecting points of the two first kinematic pairs P1 form apexes of another triangle. An area ratio of the above two triangles is within a certain range.

Specifically, the first limb L1, the second limb L2 and the third kinematic pair L3 are independently driven by a screw or a hydraulic cylinder. The five-degree-of-freedom of the movable platform 2 can be realized by controlling lengths and positions of the first limb L1, the second limb L2 and the third kinematic pair L3.

Specifically, the static platform 1 can be fixed to a planar mobile device, ao as to form a mobile parallel mechanism, wherein the five-degree-of-freedom robot is mounted upwardly and the planar mobile device is mounted downwardly.

Embodiment 1 of the third structure:

As shown in FIGS. 12-14, the parallel industrial robot comprises a static platform 1, a movable platform 2, an electric spindle 3, a first limb L1, a second limb L2, and a third limb L3.

As shown in FIGS. 12-15, two ends of the first limb L1, the second limb L2 and the third limb L3 are connected to the static platform 1 and the movable platform 2, respectively; and the electric spindle 3 is fixed in the center of the movable platform 2, which collectively constitute a five-degree-of-freedom parallel industrial robot.

Each of the first limb L1 and the second limb L2 comprises the first kinematic pair P1, the second kinematic pair P2, the ball hinge 4, and the first rotating pair R1. The first rotating pair R1 is arranged between the first kinematic pair P1 and the second kinematic pair P2, and the ball hinge 4 is provided on one end of the second kinematic pair P2.

Specifically, the third limb L3 comprises the third kinematic pair P3, the third Hooke joint U3 and the first Hooke joint U1; wherein the third kinematic pair P3 is arranged between the third Hooke joint U3 and the first Hooke joint U1.

Specifically, One ends of the first limb L1 and the second limb L2 are connected to the static platform 1 via the first kinematic pairs P1, and the other ends are connected to the movable platform 2 via the ball hinges 4. The first rotating pairs R1 are provided between the first kinematic pairs P1 and the second kinematic pairs P2. One end of the third limb L3 is connected to the static platform 1 via the third Hooke joint U3 and the other end is connected to the movable platform 2 via the first Hooke joint U1.

Specifically, the ball hinges 4 in the first limb L1 and the second limb L2 are arranged on two sides of the movable platform 2. The first kinematic pairs P1 of the first limb L1 and the second limb L2 are arranged symmetrically about a symmetry plane of the static platform 1. The two first kinematic pairs P1 form a certain angle, and are inclined and arranged on the static platform 1. The first limb L1 and the second limb L2 together are triangular. The connecting point between the first Hooke joint U1 of the third limb L3 and the movable platform 2 and the two ball hinges 4 form the apexes of a triangle. The connecting point between the third Hooke joint U3 of the third limb L3 and the static platform 1 and the connecting points of the two first rotating pairs R1 form the apexes of another triangle. The area ratio of the two triangles ranges from 1:2 to 1:9.

Specifically, the first limb L1, the second limb L2 and the third limb L3 may be independently driven by a motor or a hydraulic device. The first kinematic pairs P1 of the first limb L1 and the second limb L2 are independently driven by the motor or the hydraulic device to realize translation movements of the connecting points of the first rotating pairs R1 and the first kinematic pairs P1. The second kinematic pairs P2 are independently driven by the motor or the hydraulic device to move telescopically. The second kinematic pairs P2 cooperate with the ball hinges 4 and the first rotating pairs R1 on the two ends to realize a predetermined position of the movable platform 2. Generally, the third kinematic pair P3 of the third limb L3 is independently driven by a motor or a hydraulic device to move telescopically, and the first Hooke joint U1 and the second Hooke joint U2 of the third limb 3 also cooperate with the third kinematic pair P3 to realize the predetermined position of the movable platform 2. The foregoing structure provides the five degrees of freedom to the movable platform 2.

Embodiment 2 of the third structure:

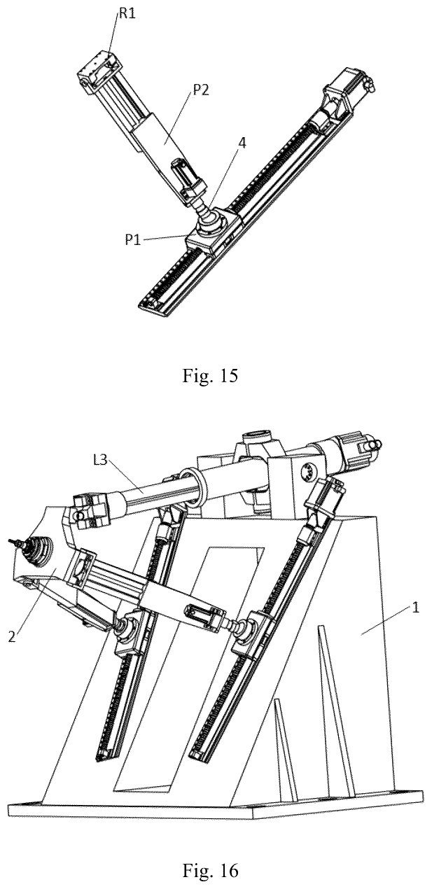

As shown in FIGS. 15-16, a motion form of the parallel industrial robot in the embodiment 2 is the same as that in the embodiment 1, and composition forms of each kinematic pair, limb, and the like are identical.

According to the embodiment 2, the difference is that the ball hinges 4 of the first limb L1 and the second limb L2 are arranged between the first kinematic pairs P1 and the second kinematic pairs P2, and the first rotating pairs R1 are provided on the other sides of the second kinematic pairs P2. That is to say, one ends of the first limb L1 and the second limb L2 are connected to the static platform 1 through the first kinematic pairs P1, and the other ends are connected to the movable platform 2 through the first rotating pairs R1.

Specifically, the first rotating pairs R1 of the first limb L1 and the second limb L2 are hinged to two sides of the movable platform 2, wherein the connecting points of the two first rotating pairs R1 and the connecting point of the third limb L3 are triangularly arranged. The connecting point of the other end of the third limb L3 and the connecting points of the ball hinges 4 are triangularly arranged. The area ratio of the above two triangles ranges from 1:2 to 1:9.

The first kinematic pairs P1 and the second kinematic pairs P2 are independently driven by a screw or a hydraulic cylinder for moving or telescoping. The ball hinges 4 and the first rotating pairs R1 cooperate to move, so as to perform corresponding movement under the predetermined position of the movable platform 2.

The above describes the basic principles, main features and beneficial effects of the present invention. Based on the embodiments of the present invention that have been described, any changes, modifications, substitutions and variations of these embodiments without departing from the principles of the present invention shall fall within the protection scope as defined by the accompanying claims.

What is claimed is:

1. A parallel robot with three limbs and five degrees of freedom, comprising: a static platform (1) as a support base, and a movable platform (2) as a position adjustment, wherein a machining output unit is provided on the movable platform (2) for executing actions; an unconstrained limb group is provided between the static platform (1) and the movable platform (2), and a constrained limb is also provided between the static platform (1) and movable platform (2) for constraining;
the constrained limb moves between the unconstrained limb group, or between extension lines of the unconstrained limb group.

2. The parallel robot, as recited in claim 1, wherein unconstrained limbs in the unconstrained limb group are connected to the static platform (1) through first kinematic pairs, and the other ends of the unconstrained limbs are connected to the movable platform (2) through movable joints.

3. The parallel robot, as recited in claim 1, wherein the unconstrained limb group comprises a first limb and a second limb, which are symmetrically disposed on the static platform (1).

4. The parallel robot, as recited in claim 2, wherein a mobile base of the first kinematic pairs is set on the static platform (1), along which mobile units of the first kinematic pairs move linearly; and first rotating pairs are provided on the mobile units of the first kinematic pairs.

5. The parallel robot, as recited in claim 4, wherein one ends of the first rotating pairs are connected to second kinematic pairs, and the second kinematic pairs move telescopically.

6. The parallel robot, as recited in claim 5, wherein one ends of the second kinematic pairs are connected to the movable platform (2) through the movable joints.

7. The parallel robot, as recited in claim 1, wherein the constrained limb is a third limb, which comprises a first Hooke joint connected to a back portion of the movable platform (2).

8. The parallel robot, as recited in claim 7, wherein the third limb comprises a third kinematic pair, a fourth kinematic pair, the first Hooke joint and a second rotating pair; wherein the third kinematic pair is arranged between the first Hooke joint and the second rotating pair, and the fourth kinematic pair is arranged at ends of the third kinematic pair and the second rotating pair;
wherein the third kinematic pair of the third limb is independently driven by a motor to move telescopically, the first Hooke joint and the second rotating pair on different ends of the third kinematic pair cooperate with the fourth kinematic pair to move, thereby moving the movable platform (2) to a predetermined position, and providing the five degrees of freedom to the movable platform (2).

9. The parallel robot, as recited in claim 7, wherein the third limb comprises a third kinematic pair, the first Hooke joint and a second Hooke joint; wherein the second Hooke joint is arranged between the first Hooke joint and the third kinematic pair;
wherein the third kinematic pair of the third limb is independently driven by a motor to slide, which cooperates with the first Hooke joint and the second Hooke joint of the third limb to execute a corresponding motion under a predetermined position, and to provide the five degrees of freedom to the movable platform (2).

10. The parallel robot, as recited in claim 7, wherein the third limb comprises a third kinematic pair, the first Hooke joint and a third Hooke joint; wherein the third kinematic pair is arranged between the first Hooke joint and the third Hooke joint;
wherein the third kinematic pair of the third limb is independently driven by a motor or a hydraulic device to move telescopically; the third kinematic pair cooperates with the first Hooke joint and the third Hooke joint on different ends to move the movable platform (2) to a predetermined position, and to provide the five degrees of freedom to the movable platform (2)
